(19) United States
(12) Patent Application Publication
(10) Pub. No.: US 2023/0374644 A1
(43) Pub. Date: Nov. 23, 2023

(54) METHOD FOR APPLYING THERMAL BARRIER COATING AND HEAT-RESISTANT MEMBER

(71) Applicant: MITSUBISHI HEAVY INDUSTRIES AERO ENGINES, LTD., Komaki-shi, Aichi (JP)

(72) Inventors: Yoshifumi OKAJIMA, Tokyo (JP); Sosuke KAWASUMI, Tokyo (JP); Taiji TORIGOE, Tokyo (JP); Takahiro SEKIGAWA, Tokyo (JP); Koji MIZUTANI, Komaki-shi, Aichi (JP); Arata KINOUCHI, Komaki-shi, Aichi (JP)

(21) Appl. No.: 18/031,529

(22) PCT Filed: Dec. 23, 2021
(86) PCT No.: PCT/JP2021/047784

§ 371 Date: Apr. 12, 2023

(30) Foreign Application Priority Data
Dec. 28, 2020 (JP) 2020-218460

(51) Int. Cl. C23C 4/129; C23C 4/02

(52) U.S. Cl. CPC C23C 4/129; C23C 4/02; C23C 4/10

(57) ABSTRACT

A method for applying a thermal barrier coating according to at least one embodiment of the present disclosure includes: a step of forming a bond coat layer by high velocity flame spraying on a heat-resistant alloy base material of an object disposed in a thermal spray booth, with a thermal spray gun disposed in the thermal spray booth; and a step of forming a top coat layer by thermal-spraying a suspension containing ceramic powder by high velocity flame spraying on the bond coat layer of the object disposed in the thermal spray booth, with the thermal spray gun disposed in the thermal spray booth.

### TECHNICAL FIELD

The present disclosure relates to a method for applying a thermal barrier coating and a heat-resistant member. This application claims the priority of Japanese Patent Application No. 2020-218460 filed on Dec. 28, 2020, the content of which is incorporated herein by reference.

### BACKGROUND

It is known that a thermal barrier coating (TBC) is provided on a heat-resistant member exposed to a high-temperature combustion gas, such as a combustor panel or a turbine blade in an aircraft engine, or a turbine blade or a ring segment in an industrial gas turbine. Such thermal barrier coating includes a bond coat layer formed on a heat-resistant alloy base material, and a top coat layer as a thermal barrier layer formed on the bond coat layer. Such thermal barrier coating includes a bond coat layer formed on a heat-resistant alloy material, and a top coat layer as a thermal barrier layer formed on the bond coat layer (see, for example, Patent Document 1).

### CITATION LIST

### Patent Literature

Patent Document 1: JP2011-117012A

### SUMMARY

### Technical Problem

For example, a bond coat layer is desired to have a high adhesion force with a heat-resistant alloy base material. Therefore, there is a need to form the bond coat layer by high velocity flame spraying in which a relatively large adhesion force is obtained by colliding raw material powder of the bond coat layer against the heat-resistant alloy base material at supersonic speed.

Further, a property or a material required for a top coat layer is different from that for the bond coat layer, and thus there is a need to form a ceramic layer by a thermal spraying method different from a thermal spraying method for forming the bond coat layer.

If the bond coat layer and the top coat layer are thus formed by the different thermal spraying methods, it is difficult to perform thermal spraying in the same thermal spray booth due to a difference in device configuration, or a difference in required peripheral device or utility such as a gas to be used. Thus, the trouble of moving an object to be thermal-sprayed to a different thermal spray booth or setup work such as setting the object until the start of thermal spraying after the object is moved is necessary.

In view of the above, an object of at least one embodiment of the present disclosure is to improve work efficiency when a thermal barrier coating is formed.

### Solution to Problem

(1) A method for applying a thermal barrier coating according to at least one embodiment of the present disclosure includes: a step of forming a bond coat layer by high velocity flame spraying on a heat-resistant alloy base material of an object disposed in a thermal spray booth, with a thermal spray gun disposed in the thermal spray booth; and a step of forming a top coat layer by thermal-spraying a suspension containing ceramic powder by high velocity flame spraying on the bond coat layer of the object disposed in the thermal spray booth, with the thermal spray gun disposed in the thermal spray booth.

(2) A heat-resistant member according to at least one embodiment of the present disclosure includes the bond coat layer and the top coat layer formed by the method for applying the thermal barrier coating according to the above method (1).

### Advantageous Effects

According to at least one embodiment of the present disclosure, it is possible to improve work efficiency when a thermal barrier coating is formed.

### BRIEF DESCRIPTION OF DRAWINGS

FIG. 1 is a schematic cross-sectional view of a heat-resistant member with a thermal barrier coating applied by a method for applying a thermal barrier coating according to some embodiments.

FIG. 2 is a view showing the appearance of a combustor panel for an aircraft engine as an example of the heat-resistant member.

FIG. 3 is a flowchart showing a procedure of the method for applying the thermal barrier coating according to some embodiments.

FIG. 4A is a view for describing an outline of a device related to the method for applying the thermal barrier coating according to an embodiment.

FIG. 4B is a view for describing an outline of the device related to the method for applying the thermal barrier coating according to another embodiment.

FIG. 4C is a view for describing an outline of the device related to the method for applying the thermal barrier coating according to still another embodiment.

FIG. 5A is a schematic view for describing a structure of an internal injection-type thermal spray gun.

FIG. 5B is a schematic view for describing a structure of an external injection-type thermal spray gun.

### DETAILED DESCRIPTION

Embodiments of the present disclosure will be described below with reference to the accompanying drawings. It is intended, however, that unless particularly identified, dimensions, materials, shapes, relative positions and the like of components described or shown in the drawings as the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same”, “equal”, and “uniform” shall not be construed as indicating only the state in which the feature is strictly equal, but also includes a state in which there is a tolerance or a difference that can still achieve the same function.

Further, for instance, an expression of a shape such as a rectangular shape or a tubular shape shall not be construed as only the geometrically strict shape, but also includes a shape with unevenness or chamfered corners within the range in which the same effect can be achieved.

On the other hand, the expressions “comprising”, “including”, “having”, “containing”, and “constituting” one constituent component are not exclusive expressions that exclude the presence of other constituent components.

### Regarding Thermal Barrier Coating 3

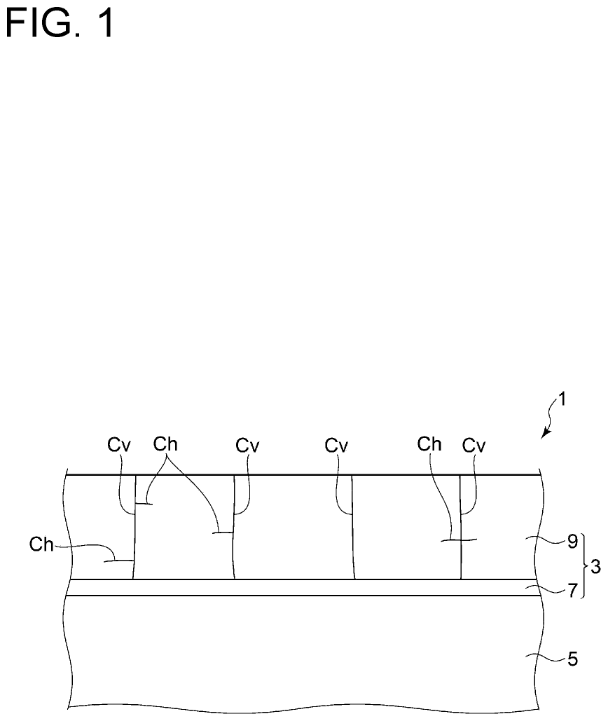

FIG. 1 is a schematic cross-sectional view of a heat-resistant member 1 with a thermal barrier coating 3 applied by a method for applying a thermal barrier coating according to some embodiments.

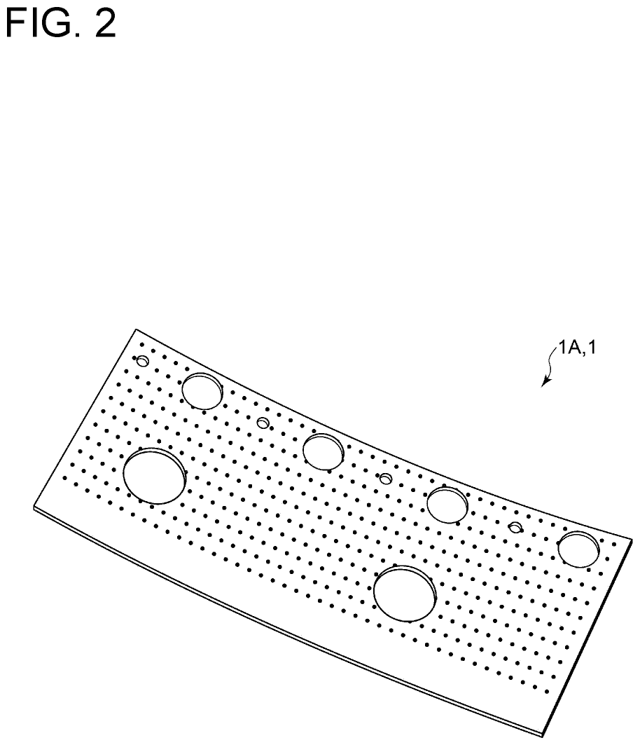

FIG. 2 is a view showing the appearance of a combustor panel 1A for an aircraft engine as an example of the heat-resistant member 1.

It is known that the thermal barrier coating (TBC) 3 for thermal barrier of the heat-resistant member 1 is formed on the heat-resistant member 1 such as the combustor panel 1A or a turbine blade for an aircraft engine, or a turbine blade or a ring segment for an industrial gas turbine.

A metal bond layer (bond coat layer) 7 and a top coat layer 9 as a thermal barrier layer are formed in this order on a heat-resistant alloy base material (base material) 5 of the heat-resistant member 1 according to some embodiments. That is, in some embodiments, the thermal barrier coating 3 includes the bond coat layer 7 and the top coat layer 9.

The bond coat layer 7 according to some embodiments is composed of, for example, McrAIY alloy (M indicates a metallic element such as Ni, Co, or Fe, or a combination of at least two of the above-described metallic elements).

The top coat layer 9 according to some embodiments is preferably composed of a ZrO₂-based material, such as YSZ (yttria-stabilized zirconia) which is ZrO₂ partially or fully stabilized with Y₂O₃. Further, the top coat layer 9 according to some embodiments may be composed of any of DySZ (dysprosia stabilized zirconia), ErSZ (erbia stabilized zirconia), Gd₂Zr₂O₇, or Gd₂Hf₂O₇.

Whereby, the thermal barrier coating 3 having excellent thermal barrier properties is obtained.

In the top coat layer 9 according to some embodiments, vertical cracks Cv extending in the thickness direction of the top coat layer 9 are dispersed in the plane direction, that is, in the horizontal direction and the depth direction of the drawing in FIG. 1. Further, in the top coat layer 9 according to some embodiments, horizontal cracks Ch extending in the plane direction are dispersed.

In the thermal barrier coating 3 according to some embodiments, the structure of the top coat layer 9 with the plurality of vertical cracks Cv can alleviate the occurrence of a thermal stress due to a difference in linear expansion coefficient from the heat-resistant alloy base material 5, obtaining excellent heat cycle durability.

### Flowchart

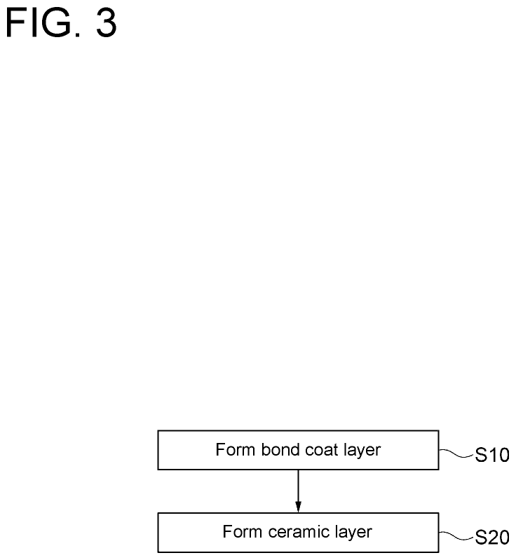

FIG. 3 is a flowchart showing a procedure of the method for applying the thermal barrier coating according to some embodiments. The method for applying the thermal barrier coating according to some embodiments includes a step S10 of forming the bond coat layer 7 and a step S20 of forming the top coat layer 9.

In some embodiments, the step S10 of forming the bond coat layer 7 is a step of forming the bond coat layer 7 by high velocity thermal spraying on the heat-resistant alloy base material 5 of the object (heat-resistant member 1) disposed in a thermal spray booth 20 described later, with a thermal spray gun 30 disposed in the thermal spray booth 20 and described later.

That is, in some embodiments, the step S10 of forming the bond coat layer 7 includes thermal-spraying powder such as a MCrAlY alloy as a thermal spray material onto the surface of the heat-resistant alloy base material 5 by high velocity flame spraying.

In some embodiments, the step S20 of forming the top coat layer 9 is a step of forming the top coat layer 9 on the bond coat layer 7 of the above-described object (heat-resistant member 1), which is disposed in the thermal spray booth 20 where the step S10 of forming the bond coat layer 7 is performed, by thermal-spraying a suspension containing ceramic powder by high velocity flame spraying, with the thermal spray gun 30 disposed in the thermal spray booth 20.

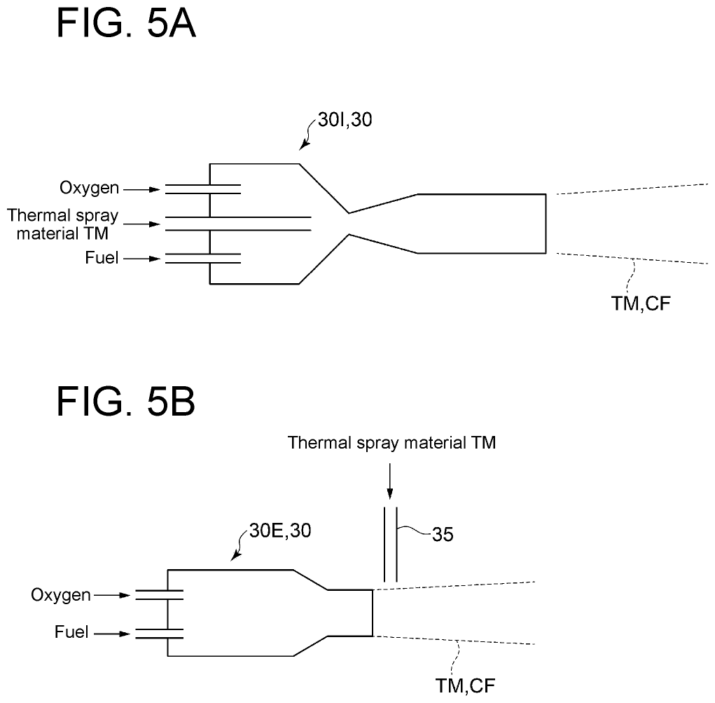

That is, in some embodiments, the thermal spraying performed in the step S20 of forming the top coat layer 9 is suspension high velocity oxygen fuel spraying (S-HVOF). In some embodiments, the step S20 of forming the top coat layer 9 includes thermal-spraying a suspension, which is obtained by dispersing ceramic powder as the thermal spray material in a solvent, onto the surface of the bond coat layer 7 by high velocity flame spraying. In suspension high velocity flame spraying, a thermal spray material TM injected as the suspension is sprayed onto the surface of the object to be thermal-sprayed by a combustion flame jet flow CF (see FIG. 5A, 5B described later).

High velocity oxygen fuel spraying (HVOF) and suspension high velocity oxygen fuel spraying (S-HVOF) are different in whether a raw material (thermal spray material) used for thermal spraying is injected in the form of powder as is or a suspension dispersed in a solvent, but both are thermal spraying methods using high velocity flame spraying device. Thus, although there is a difference in device configuration, such as the thermal spray gun 30, between high velocity flame spraying and suspension high velocity flame spraying, there is almost no difference in necessary peripheral device or utility such as a gas to be used. Therefore, the thermal spray gun 30 for performing high velocity flame spraying and the thermal spray gun 30 for performing suspension high velocity flame spraying can be disposed in the same thermal spray booth 20 to perform thermal spraying.

Accordingly, with the method for applying the thermal barrier coating according to some embodiments, since it is not necessary to move the heat-resistant member 1 as the object to another thermal spray booth after the bond coat layer 7 is formed, the trouble of moving the heat-resistant member 1 to the different thermal spray booth becomes unnecessary and setup work such as setting the heat-resistant member 1 until the start of thermal spraying by suspension high velocity flame spraying can greatly be reduced, improving work efficiency when the thermal barrier coating 3 is formed and making it possible to reduce a manufacturing cost.

Conventionally, in order to ensure heat cycle durability, the top coat layer 9 is often formed by electron beam physical vapor deposition (EB-PVD) so as to internally include a crack (vertical crack Cv) which is called a vertical crack extending in the thickness direction of the top coat layer 9. However, an initial cost of a device for performing electron beam physical vapor deposition is more than ten times as high as that of a thermal spraying device or the like. Further, a running cost for forming a layer by electron beam physical vapor deposition is about ten times as high as a running cost for forming a layer by thermal spraying or the like. Furthermore, a speed of layer formation by electron beam physical vapor deposition is as low as a fraction of a speed of layer formation by thermal spraying or the like.

As a result of intensive studies by the present inventors, it was found that the performance such as thermal barrier properties or thermal cycle durability equivalent to that in the case of forming the top coat layer on the bond coat layer 7 by electron beam physical vapor deposition can be ensured, if the top coat layer is formed by thermal-spraying the suspension containing ceramic powder by high velocity flame spraying.

With the method for applying the thermal barrier coating according to some embodiments, the top coat layer 9 can be formed at a lower running cost and in a shorter time than in the case where the top coat layer 9 is formed on the bond coat layer 7 by electron beam physical vapor deposition. Further, with the method for applying the thermal barrier coating according to some embodiments, it is also possible to greatly reduce an introduction cost of equipment for forming the top coat layer 9.

Further, the heat-resistant member 1 according to some embodiments includes the bond coat layer 7 and the top coat layer 9 formed by the method for applying the thermal barrier coating according to some embodiments.

Thus, it is possible to suppress the manufacturing cost of the heat-resistant member 1.

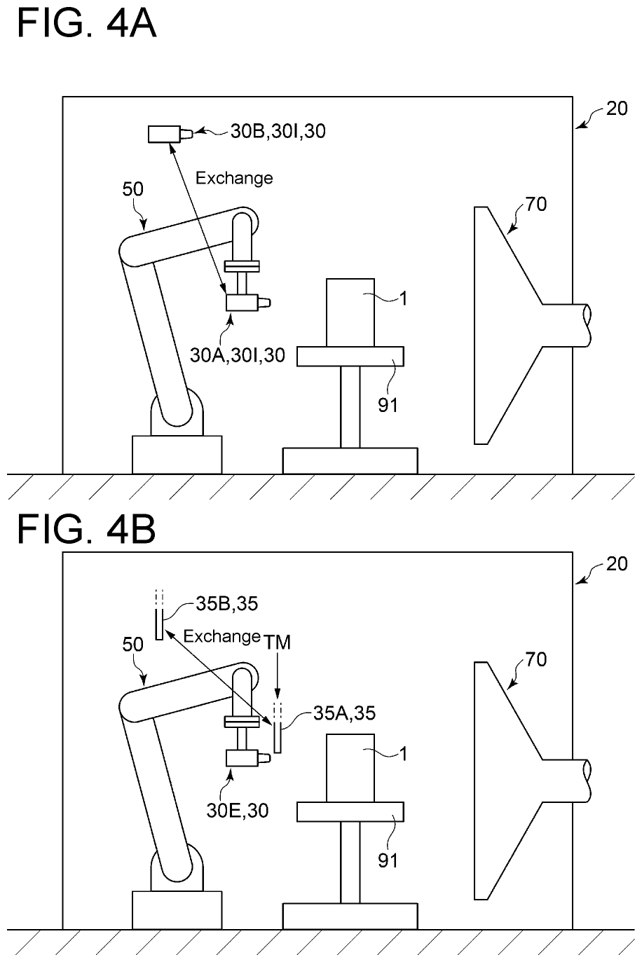

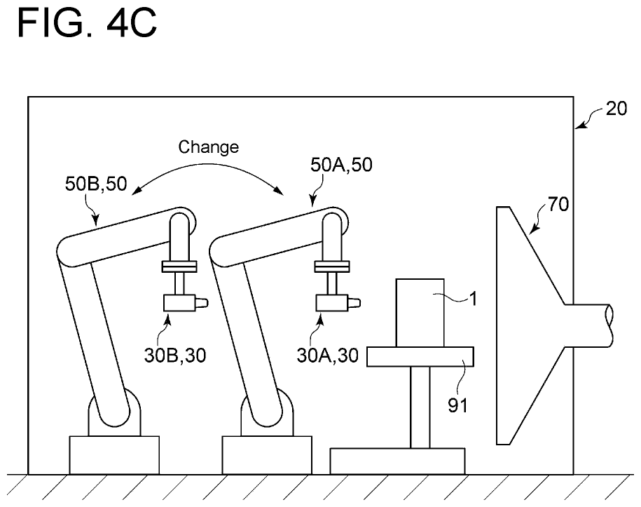

FIG. 4A is a view for describing an outline of a device related to the method for applying the thermal barrier coating according to an embodiment.

FIG. 4B is a view for describing an outline of the device related to the method for applying the thermal barrier coating according to another embodiment.

FIG. 4C is a view for describing an outline of the device related to the method for applying the thermal barrier coating according to still another embodiment.

FIG. 5A is a schematic view for describing a structure of an internal injection-type thermal spray gun 30I.

FIG. 5B is a schematic view for describing a structure of an external injection-type thermal spray gun 30E.

As shown in FIGS. 4A to 4C, the method for applying the thermal barrier coating according to some embodiments includes applying the thermal barrier coating 3 by using a thermal spray gun 30, a moving device 50 for the thermal spray gun 30, and a dust collection hood 70. In the method for applying the thermal barrier coating according to some embodiments, in addition to these devices shown in FIGS. 4A to 4C, although not shown, a thermal spray control panel, a controller for controlling driving of the moving device 50, a thermal spray material injection device, or the like is also included in the device configuration.

In the application of the thermal barrier coating 3, a fixing jig 91 may be used if it is necessary to fix the heat-resistant member 1 which is the object to be applied with the thermal barrier coating 3, and a rotation driving device (not shown) may be used if it is necessary to continuously rotate the heat-resistant member 1.

The moving device 50 according to some embodiments is, for example, an industrial robot, but may be, for example, a scanning device, such as an NC device, having a slide shaft movable in multiple directions.

As shown in FIGS. 4A to 4C, in the method for applying the thermal barrier coating according to some embodiments, for example, the thermal spray gun 30, the moving device 50, and the dust collection hood 70 are disposed in one thermal spray booth 20. The thermal spray booth 20 forms a space partitioned off from surroundings for sound insulation or prevention of dust scattering to the surroundings. For example, the thermal spray booth 20 may be a box disposed in a working room, may be a section in which a part of the working room is partitioned by a wall or the like, or may be a dedicated room provided in a building.

The heat-resistant member 1, which is the object to be applied with the thermal barrier coating 3, is formed with the thermal barrier coating 3, that is, the bond coat layer 7 and the top coat layer 9, in the thermal spray booth 20.

As shown in FIG. 4A, in the method for applying the thermal barrier coating according to an embodiment, the step S10 of forming the bond coat layer 7 may include forming the bond coat layer 7 by high velocity flame spraying while moving a first thermal spray gun 30A by the moving device 50. Then, the step of forming the top coat layer 9 may include forming the top coat layer while moving a second thermal spray gun 30B different from the first thermal spray gun 30A by the moving device 50 used in the step S10 of forming the bond coat layer 7.

That is, in the method for applying the thermal barrier coating according to an embodiment shown in FIG. 4A, the thermal spray gun 30 to be used (the thermal spray gun 30 to be attached to the moving device 50) is exchanged between the step S10 of forming the bond coat layer 7 and the step of forming the top coat layer 9. Thus, the step S10 of forming the bond coat layer 7 and the step of forming the top coat layer 9 can be performed in the same thermal spray booth 20.

For example, when using an internal injection-type thermal spray gun 30I as shown in FIG. 5A which is configured to inject the thermal spray material TM to the inside of the thermal spray gun 30, the thermal spray gun 30 to be used can be exchanged between the step S10 of forming the bond coat layer 7 and the step of forming the top coat layer 9.

With the method for applying the thermal barrier coating according to an embodiment shown in FIG. 4A, after the formation of the bond coat layer 7, if the thermal spray gun 30 attached to the moving device 50 is changed from the first thermal spray gun 30A to the second thermal spray gun 30B before the formation of the top coat layer 9, the moving device 50 may not be changed, making it possible to simplify the setup work until the start of the formation of the top coat layer 9 after the formation of the bond coat layer 7.

As shown in FIG. 4B, in the method for applying the thermal barrier coating according to another embodiment, the step S10 of forming the bond coat layer 7 may include forming the bond coat layer 7 by high velocity frame spraying while moving the thermal spray gun 30 by the moving device 50. Then, the step S20 of forming the top coat layer 9 may include forming the top coat layer 9 while moving the thermal spray gun 30, which is used in the step S10 of forming the bond coat layer 7, by the moving device 50 used in the step S10 of forming the bond coat layer 7.

That is, in the method for applying the thermal barrier coating according to another embodiment shown in FIG. 4B, the step S10 of forming the bond coat layer 7 and the step S20 of forming the top coat layer 9 are performed with the same thermal spray gun 30, without exchanging the thermal spray gun 30 (the thermal spray gun 30 to be attached to the moving device 50) between the step S10 of forming the bond coat layer 7 and the step S20 of forming the top coat layer 9.

With the method for applying the thermal barrier coating according to another embodiment shown in FIG. 4B, after the formation of the bond coat layer 7 and before the formation of the top coat layer 9, as will be described later, if, for example, a powder injection part 35 for injecting the thermal spray material TM of the bond coat layer 7 is changed to the powder injection part 35 for injecting the thermal spray material TM of the top coat layer 9, the moving device 50 and the thermal spray gun 30 may not be changed. Thus, it is possible to simplify the setup work until the start of the formation of the top coat layer 9 after the formation of the bond coat layer 7.

The bond coat layer 7 and the top coat layer 9 are different in thermal spray material, and in addition, are different in whether the thermal spray material is injected in the form of powder as is or a suspension. Therefore, in the method for applying the thermal barrier coating according to another embodiment shown in FIG. 4B, as the thermal spray gun 30, it is preferable to use, for example, the external injection-type thermal spray gun 30E as shown in FIG. 5B which is configured to inject the thermal spray material TM outside the thermal spray gun 30. Then, the powder injection part 35, which is attached to the outside of the external injection-type thermal spray gun 30E and is configured to inject the thermal spray material TM to the combustion flame jet flow CF, is preferably exchanged between the step S10 of forming the bond coat layer 7 and the step of forming the top coat layer 9. That is, in the method for applying the thermal barrier coating according to another embodiment shown in FIG. 4B, it is preferable to exchange the powder injection part 35 for the thermal spray material TM between the step S10 of forming the bond coat layer 7 and the step S20 of forming the top coat layer 9.

More specifically, in the method for applying the thermal barrier coating according to another embodiment shown in FIG. 4B, when the step S10 of forming the bond coat layer 7 is performed, it is preferable to attach a first powder injection part 35A for injecting the thermal spray material TM of the bond coat layer 7 to the external injection-type thermal spray gun 30E. Further, when the step S20 of forming the top coat layer 9 is performed, it is preferable to attach a second powder injection part 35B for injecting the thermal spray material TM of the top coat layer 9 to the external injection-type thermal spray gun 30E.

Thus, the step S10 of forming the bond coat layer 7 and the step of forming the top coat layer 9 can be performed in the same thermal spray booth 20.

The first powder injection part 35A and the second powder injection part 35B are connected to a powder injection device (not shown) for injecting the thermal spray material TM to the first powder injection part 35A and the second powder injection part 35B.

With the method for applying the thermal barrier coating according to another embodiment shown in FIG. 4B, after the formation of the bond coat layer 7 and before the formation of the top coat layer 9, if the first powder injection part 35A is changed to the second powder injection part 35B, the moving device 50 and the thermal spray gun 30 may not be changed, making it possible to simplify the setup work until the start of the formation of the top coat layer 9 after the formation of the bond coat layer 7.

As shown in FIG. 4C, in the method for applying the thermal barrier coating according to still another embodiment, the step S10 of forming the bond coat layer 7 may include forming the bond coat layer 7 by high velocity flame spraying while moving the first thermal spray gun 30A by a first moving device 50A. Then, the step S20 of forming the top coat layer 9 may include forming the top coat layer 9 while moving the second thermal spray gun 30B different from the first thermal spray gun 30A by a second moving device 50B different from the first moving device 50A.

In the method for applying the thermal barrier coating according to still another embodiment shown in FIG. 4C, the moving device 50 and the thermal spray gun 30 to be used are changed between the step S10 of forming the bond coat layer 7 and the step of forming the top coat layer 9. Thus, the step S10 of forming the bond coat layer 7 and the step of forming the top coat layer 9 can be performed in the same thermal spray booth 20.

With the method for applying the thermal barrier coating according to still another embodiment shown in FIG. 4C, by using the first moving device 50A and the first thermal spray gun 30A as the devices for forming the bond coat layer 7 and using the second moving device 50B and the second thermal spray gun 30B as the devices for forming the top coat layer 9, it is possible to omit the exchange work of the thermal spray gun 30, the exchange work of the powder injection part 35, or the like in the setup work until the start of the formation of the top coat layer 9after the formation of the bond coat layer 7.

The present disclosure is not limited to the above-described embodiments, and also includes an embodiment obtained by modifying the above-described embodiments or an embodiment obtained by combining these embodiments as appropriate.

The contents described in the above embodiments would be understood as follows, for instance.

(1) A method for applying a thermal barrier coating according to at least one embodiment of the present disclosure includes a step (S10) of forming a bond coat layer 7 by high velocity flame spraying on a heat-resistant alloy base material 5 of an object (heat-resistant member 1) disposed in a thermal spray booth 20, with a thermal spray gun 30 disposed in the thermal spray booth 20. The method for applying the thermal barrier coating according to at least one embodiment of the present disclosure includes a step (S20) of forming a top coat layer 9 by thermal-spraying a suspension containing ceramic powder by high velocity flame spraying on the bond coat layer 7 of the above-described object (heat-resistant member 1) disposed in the thermal spray booth 20, with the thermal spray gun 30 disposed in the thermal spray booth 20.

With the above method (1), since it is not necessary to move the object (heat-resistant member 1) to another thermal spray booth after the bond coat layer 7 is formed, the trouble of moving the object (heat-resistant member 1) to be thermal-sprayed to the different thermal spray booth becomes unnecessary and setup work such as setting the object (heat-resistant member 1) until the start of thermal spraying by suspension high velocity flame spraying can greatly be reduced, improving work efficiency when the thermal barrier coating 3 is formed and making it possible to reduce a manufacturing cost.

Further, with the above method (1), the top coat layer 9 can be formed at a lower running cost and in a shorter time than in the case where the top coat layer 9 is formed on the bond coat layer 7 by electron beam physical vapor deposition. Furthermore, with the above method (1), it is also possible to greatly reduce an introduction cost of equipment for forming the top coat layer 9.

(2) In some embodiments, in the above method (1), the step (S10) of forming the bond coat layer 7 by high velocity flame spraying may include forming the bond coat layer 7 by high velocity flame spraying while moving a first thermal spray gun 30A by a first moving device 50A. Then, the step (S20) of forming the top coat layer 9 may include forming the top coat layer 9 while moving a second thermal spray gun 30B different from the first thermal spray gun 30A by a second moving device 50B different from the first moving device 50A.

With the above method (2), by using the first moving device 50A and the first thermal spray gun 30A as the devices for forming the bond coat layer 7 and using the second moving device 50B and the second thermal spray gun 30B as the devices for forming the top coat layer 9, it is possible to omit the exchange work of the thermal spray gun 30, the exchange work of the powder injection part 35, or the like in the setup work until the start of the formation of the top coat layer 9 after the formation of the bond coat layer 7.

(3) In some embodiments, in the above method (1), the step (S10) of forming the bond coat layer 7 by high velocity flame spraying may include forming the bond coat layer 7 by high velocity flame spraying while moving a first thermal spray gun 30A by a moving device 50. Then, the step (S20) of forming the top coat layer 9 may include forming the top coat layer 9 while moving a second thermal spray gun 30B different from the first thermal spray gun 30A by the moving device 50.

With the above method (3), after the formation of the bond coat layer 7, if the thermal spray gun 30 to be attached to the moving device 50 is changed from the first thermal spray gun 30A to the second thermal spray gun 30B before the formation of the top coat layer 9, the moving device 50 may not be changed, making it possible to simplify the setup work until the start of the formation of the top coat layer 9 after the formation of the bond coat layer 7.

(4) In some embodiments, in the above method (1), the step (S10) of forming the bond coat layer 7 by high velocity flame spraying may include forming the bond coat layer 7 by high velocity flame spraying while moving the thermal spray gun 30 by a moving device50. Then, the step (S20) of forming the top coat layer 9 may include forming the top coat layer 9 while moving the thermal spray gun 30 by the moving device 50.

With the above method (4), after the formation of the bond coat layer 7 and before the formation of the top coat layer 9, for example, if the powder injection part 35 for injecting the thermal spray material TM of the bond coat layer 7 is changed to the powder injection part 35 for injecting the thermal spray material TM of the top coat layer 9, the moving device 50 and the thermal spray gun 30 may not be changed, making it possible to simplify the setup work until the start of the formation of the top coat layer 9 after the formation of the bond coat layer 7.

(5) In some embodiments, in the above method (4), a powder injection part 35 for a thermal spray material TM to be thermal-sprayed with the thermal spray gun 30 is preferably changed between the step (S10) of forming the bond coat layer 7 by high velocity flame spraying and the step (S20) of forming the top coat layer 9.

With the above method (5), after the formation of the bond coat layer 7 and before the formation of the top coat layer 9, if the powder injection part (first powder injection part 35A) for injecting the thermal spray material TM for forming the bond coat layer 7 is changed to the powder injection part (second powder injection part 35B) for injecting the thermal spray material TM for forming the top coat layer 9, the moving device 50 and the thermal spray gun 30 may not be changed, making it possible to simplify the setup work until the start of the formation of the top coat layer 9 after the formation of the bond coat layer 7.

(6) A heat-resistant member 1 according to at least one embodiment of the present disclosure includes the bond coat layer 7 and the top coat layer 9 formed by the method for applying the thermal barrier coating according to any one of the above methods (1) to (5).

With the above configuration (6), it is possible to suppress the manufacturing cost of the heat-resistant member 1.

### REFERENCE SIGNS LIST

1 Heat-resistant member
3 Thermal barrier coating (TBC)
5 Heat-resistant alloy base material (base material)
7 Metal bond layer (bond coat layer)
9 Top coat layer
20 Thermal spray booth
30 Thermal spray gun
35 Powder injection part
50 Moving device

1. A method for applying a thermal barrier coating, comprising:
a step of forming a bond coat layer by high velocity flame spraying on a heat-resistant alloy base material of an object disposed in a thermal spray booth, with a thermal spray gun disposed in the thermal spray booth; and
a step of forming a top coat layer by thermal-spraying a suspension containing ceramic powder by high velocity flame spraying on the bond coat layer of the object disposed in the thermal spray booth, with the thermal spray gun disposed in the thermal spray booth.

2. The method for applying the thermal barrier coating according to claim 1,
wherein the step of forming the bond coat layer by high velocity flame spraying includes forming the bond coat layer by high velocity flame spraying while moving a first thermal spray gun by a first moving device, and
wherein the step of forming the top coat layer by thermal-spraying the suspension containing the ceramic powder by high velocity flame spraying includes forming the top coat layer while moving a second thermal spray gun different from the first thermal spray gun by a second moving device different from the first moving device.

3. The method for applying the thermal barrier coating according to claim 1,
wherein the step of forming the bond coat layer by high velocity flame spraying includes forming the bond coat layer by high velocity flame spraying while moving a first thermal spray gun by a moving device, and
wherein the step of forming the top coat layer by thermal-spraying the suspension containing the ceramic powder by high velocity flame spraying includes forming the top coat layer while moving a second thermal spray gun different from the first thermal spray gun by the moving device.

4. The method for applying the thermal barrier coating according to claim 1,
wherein the step of forming the bond coat layer by high velocity flame spraying includes forming the bond coat layer by high velocity flame spraying while moving the thermal spray gun by a moving device, and
wherein the step of forming the top coat layer by thermal-spraying the suspension containing the ceramic powder by high velocity flame spraying includes forming the top coat layer while moving the thermal spray gun by the moving device.

5. The method for applying the thermal barrier coating according to claim 4,
wherein a powder injection part for a thermal spray material to be thermal-sprayed with the thermal spray gun is changed between the step of forming the bond coat layer by high velocity flame spraying and the step of forming the top coat layer by thermal-spraying the suspension containing the ceramic powder by high velocity flame spraying.

6. A heat-resistant member comprising the bond coat layer and the top coat layer formed by the method for applying the thermal barrier coating according to claim 1.
